(19) United States
(12) Patent Application Publication
(10) Pub. No.: US 2015/0084413 A1
(43) Pub. Date: Mar. 26, 2015

(54) METHOD AND SYSTEM FOR SUPPLYING ELECTRIC POWER TO A HYBRID MOTOR VEHICLE WITH DUAL ELECTRICAL ENERGY STORAGE DEVICES

(71) Applicant: VALEO EQUIPMENTS ELECTRIQUES MOTEUR, Creteil Cedex (FR)

(72) Inventors: Daniel Benchetrite, Creteil (FR); Mathilde Ouattara-Brigaudet, Creteil (FR); Philippe Baudesson, La Boissiere (FR); Marc Ranier, Villeneuve Le Roi (FR)

(21) Appl. No.: 14/388,605

(22) PCT Filed: Mar. 22, 2013
(86) PCT No.: PCT/FR2013/050623

§ 371 Date: Sep. 26, 2014

(30) Foreign Application Priority Data
Mar. 28, 2012 (FR) 1252766

(51) Int. Cl. B60L 11/18; H02J 7/14; B60L 11/12

(52) U.S. Cl. CPC B60L 11/18; B60L 11/12; H02J 7/14; B60L 11/1809
USPC 307/10.1

(57) ABSTRACT

Method used in a vehicle provided with an electrical power system (1), including an electrical engine/generator (3) and first electrical power storage (2) having a first nominal voltage, and moreover provided with a backup electrical system (5), including a second electrical power storage (6) having a second nominal voltage less than the first nominal voltage. The electrical power system and the backup system are connected by a reversible DC/DC converter (9). A first optimal power current strength (IESS1), flowing in the first storage (2), and a second optimal power current strength (IESS2), flowing in the second storage (6), are determined on the basis of operational parameters for the first and second electrical power storages so as to minimize losses due to heat dissipation. The first and second optimal power current strengths (IESS1, IESS2) are also determined on the basis of a reversible DC/DC converter output.

### TECHNICAL FIELD OF THE INVENTION

The present invention relates to a method for supplying electric power to a hybrid motor vehicle with dual energy storage devices, as well as to a system for supplying electric power to a hybrid motor vehicle which can implement this method.

### TECHNOLOGICAL BACKGROUND OF THE INVENTION

Motor vehicles with a thermal engine conventionally comprise an on-board electrical network comprising a battery, generally a 12 V battery, which is designed to supply electrical energy to the various items of equipment, and in particular a starter, which is indispensable for ensuring the starting of the thermal engine. After the starting, an alternator which is coupled to the thermal engine is responsible for charging the battery.

Nowadays, the development of electronic power makes it possible to supply and control a single reversible polyphase rotary electrical machine, which advantageously replaces the starter and the alternator.

In an initial stage, this machine, which is known by the name of an alternator-starter, essentially served the purpose of fulfilling the functions which were previously carried out by the alternator and the starter, and in addition, of recuperating the braking energy, or supplying the thermal engine with additional power and torque.

For the purpose of increasing the power, and improving the performance of the alternator-starter by increasing its functioning voltage, whilst maintaining the possibility of using other standard equipment designed for a 12 V to 14 V supply, in particular lead batteries, a so-called “14+X” or “micro-hybrid” architecture has been developed, which is described for example in patent application FR2328576.

This architecture therefore consists of an electric power network which connects the alternator-starter to an electrical energy storage element which functions at a voltage higher than 14 V, and can be as high as 48 V, and of an electric service network which connects all the other equipment. The adaptation of the voltage levels between the two networks is ensured by a reversible direct/direct converter.

In a second stage, ecological considerations led to the design of alternator-starters with power of approximately 8 to 10 kW, which is sufficient to drive the vehicle at low speed, for example in an urban environment.

Power levels of this type have been able to be obtained whilst continuing to have compact electrical machines only by increasing the voltage of the electric power network to a voltage far higher than the nominal voltage of 12 V of the conventional lead batteries, and generally to a voltage which can be as high as a maximum of 60 V.

In addition, power networks with voltages of up to 120 V can be implemented in an architecture which allows the vehicle to be driven at full speed by the electric motor (so-called full-hybrid architecture, in comparison with the previous so-called mild-hybrid architecture).

In the present state of the art, constraints of reliability of the high-voltage reversible direct/direct converter, of arrangement under the engine bonnet, or of cost, often make it necessary to keep using the conventional alternator in the electric service network.

For the same reasons, and also because of the specific charging/discharging characteristics of the lead batteries, a conventional starter supplied by the service network and the lead battery often continue to be standard equipment.

In order to carry out the aforementioned functions specific to hybrid vehicles, substantial power is supplied essentially by the storage element of the power network.

Thus, this storage element is subjected to severe constraints, and lithium-ion batteries are habitually used.

A storage element of this type must have very low internal resistance, in order to prevent voltage losses during the discharging phases, and excess voltages during the charging phases, and at the same time it must have an energy level which is sufficient to be able to supply the energy in a running phase in a mode which is purely electrical (known as “ZEV” for “zero emission vehicle”).

These specifications are difficult to fulfil using lithium-ion batteries with an acceptable cost, and a further financial constraint is added when this storage element is selected.

During a recuperative braking phase, the energy restored must be directed to the high-voltage battery, and if possible to the low-voltage battery. Conversely, during phases of torque assistance or ZEV, the energy must be obtained from the high-voltage battery and/or from the low-voltage battery.

These batteries must all have high internal resistance, which leads to substantial losses by thermal dissipation.

### GENERAL DESCRIPTION OF THE INVENTION

In these circumstances, the object of the present invention is thus to determine a strategy for controlling the electrical energy, with a pair of high- and low-voltage batteries, thus tending to limit these losses.

In general, the invention relates to a process for supplying electric power to a hybrid motor vehicle with dual energy storage devices.

This method is of the type which in itself is known, consisting of providing the vehicle firstly with an electric power network comprising an electric motor/generator, and a first electrical energy storage device with a first nominal voltage, and secondly with an electric service network comprising a second electrical energy storage device with a second nominal voltage which is lower than the first nominal voltage, the electric power network and the service network being connected to one another by a reversible direct/direct converter.

The method according to the invention is distinguished in that a first optimum intensity is determined, which circulates in the first storage device, and a second optimum intensity is determined, which circulates in the second storage device, according to functioning parameters of these storage devices, such as to minimise losses by thermal dissipation.

These first and second optimum intensities are also advantageously determined according to a performance level of the reversible direct/direct converter.

Preferably, these optimum first and second intensities are also determined in accordance with a functioning intensity which circulates in a branch of the electric power network comprising the motor/generator.

In the method for supplying electric power to a hybrid motor vehicle with dual electrical energy storage devices according to the invention, the functioning parameters of the storage devices taken into account are preferably electric parameters of a lithium-ion battery and a nickel-zinc battery.

The invention also relates to a system for supplying electric power to a hybrid motor vehicle with dual electrical energy storage devices which can implement the above-described method.

According to a known architecture, this system comprises firstly an electric power network comprising an electric motor/generator, and a first electrical energy storage device with a first nominal voltage, and secondly an electric service network comprising a second electrical energy storage device with a second nominal voltage which is lower than this first nominal voltage, the electric power network being connected to the service network by a reversible direct/direct converter.

The system for supplying electric power to a hybrid motor vehicle with dual electrical energy storage devices according to the invention is distinguished in that it additionally comprises an electronic control unit which controls a set intensity which circulates in the reversible direct/direct converter according to functioning parameters of the first and second electrical energy storage devices.

The second electrical energy storage device of this system is selected so as to have, highly advantageously:

a discharge curve which is substantially flat between 20% and 80% of a nominal capacity;

a number of charging/discharging cycles greater than 1000;

a faradic performance which is substantially 99% or more;

a power density at low temperature higher than 480 W/kg.

The battery is preferably a nickel-zinc battery.

The invention also relates to an electronic control unit which can be integrated in the electrical supply system of a hybrid motor vehicle with dual electrical energy storage devices as previously described.

This electronic control unit is distinguished in that it comprises an electronic memory comprising data representative of the functioning parameters of the first and second electrical energy storage devices, and a computer code which is representative of the method according to the invention. Within the context of the invention, a hybrid motor vehicle will also advantageously be provided with the electrical supply system with dual electrical energy storage devices as described above.

These few essential specifications will have made apparent to persons skilled in the art the advantages provided by the method and the system for redundant electrical supply to a hybrid motor vehicle, in comparison with the prior art.

The detailed specifications of the invention are provided in the description which follows in association with the appended drawings. It should be noted that these drawings serve the purpose simply of illustrating the text of the description, and do not constitute in any way a limitation of the scope of the invention.

### BRIEF DESCRIPTION OF THE DRAWINGS

FIG. 1 is an electrical diagram of an electrical supply system of a hybrid motor vehicle with dual storage devices according to the invention.

FIGS. 2a, 2b and 2c illustrate the functioning parameters of a nickel-zinc battery implemented as a second energy storage device in a preferred mode of the invention.

### DESCRIPTION OF PREFERRED EMBODIMENTS OF THE INVENTION

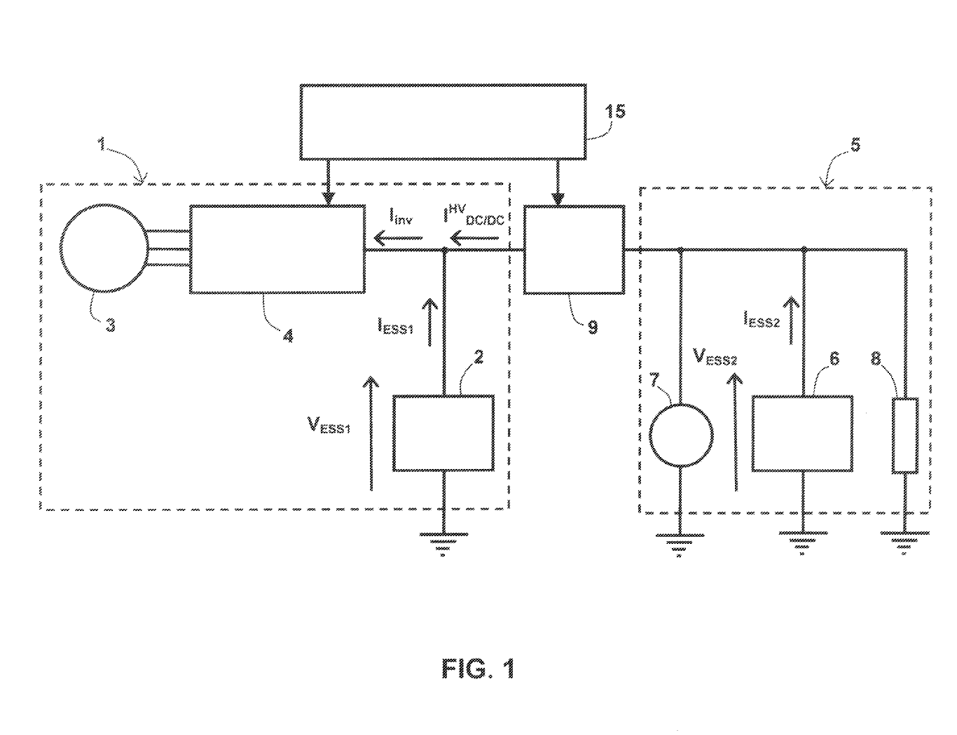

A reminder, provided in association with FIG. 1, of the characteristics of an electrical supply system of a hybrid motor vehicle known in the prior art in a so-called mild-hybrid architecture, will make it possible to understand well the contribution made by the invention.

FIG. 1 shows schematically a first electrical power network 1 comprising a first electrical energy storage device 2 and an electric motor/generator 3.

Mostly, this motor/generator 3 is a three-phase machine comprising a rotor comprising an excitation winding and a stator comprising phase windings.

When the motor/generator 3 is in motor mode, an excitation circuit supplies an excitation current to the rotor, and a direct/alternating converter 4 functioning as an inverter supplies power to the phase windings of the stator, from the first electrical energy storage device 2.

When the motor/generator 3 is in generator mode, the direct/alternating converter 4 functions as a synchronous rectifier, and the excitation circuit controls the charge voltage of the first electrical energy storage device 2.

FIG. 1 shows schematically an electric service network 5 comprising a second electrical energy storage device 6 which is connected permanently, and a starter 7 or other electric charges 8 which are activated on demand.

According to the prior art, this second storage device 6 is generally a standard lead battery which supplies power to a starter 7, which is also standard, at the moment of putting into contact.

The electrical energy storage element 2 is frequently a lithium-ion battery with a low (or medium) capacity, and a high first nominal voltage, for example of 48 V.

As shown clearly in FIG. 1, the electric power network 1 and the electric service network 5 are connected to one another.

The electric power network 1 can supply electrical energy to the electric service network 5 and charge the lead battery 6, whereas the service network 5 can reciprocally supply electrical energy to the power network 1, for example when the lithium battery 2 is discharged.

The limit discharge voltage of a lithium battery 2 of a common type with a first nominal voltage of 48 V is approximately 35 V, and its maximum voltage is approximately 60 V.

A voltage at the terminals of the lead battery 6 with a second nominal voltage of 12 V varies between approximately 11 V when it is discharged, and approximately 14 V when is charged.

A reversible direct/direct converter 9 thus ensures the adaptation of the voltage levels between the two electrical networks 1,5.

This converter 9 is generally a converter with switching semiconductors fitted with a “common mass” with the two batteries 2, 6.

Thus, a functioning intensity Iᵢₙᵥ which circulates in the branch of the electric power network 1 comprising the motor/generator 3 in series with the alternating/direct converter 4, is distributed between a first intensity I_{EES1} in the first electrical energy storage device 2, and a supply intensity I^{HV}_{DC/DC} which is used to supply to the second electrical energy storage device 6 a second intensity I_{EES2} via the reversible direct/direct converter 9.

These different intensities which circulate in the different electrical elements of the power and service 5 networks, in particular the storage devices 2,6, produce losses by thermal dissipation which the method according to the invention tends to minimise by controlling their distribution between the two networks 1,5.

With reference to FIG. 1, the total power dissipated can be determined by the following equations:

Iᵢₙᵥ=I_{ESS1}+I_{DC/DC}^{HV}

where:
Iᵢₙᵥ: intensity of functioning of the reversible AC/DC converter 4
I_{ESS1}: first intensity in the first electrical energy storage device 2 to be optimised
I_{DC/DC}^{HV}: intensity of the supply at the input of the DC/DC converter 9

V_{ESS1}·I_{DC/DC}^{HV}=η·V_{ESS2}·I_{ESS2}

where:
V_{ESS1}: first functioning voltage of the first electrical energy storage device 2
η: performance of the reversible DC/DC converter 9
V_{ESS2}: second functioning voltage of the second electrical energy storage device 6
I_{ESS2}: second intensity in the second electrical energy storage device 6 to be optimised

The following then applies:

P+R_{ESS1}·I_{ESS1}²+(1−η)·V_{ESS2}·I_{DC/DC}^{HV}+r_{ESS2}·I_{ESS2}²

where:
P=total losses in the system
R_{ESS1}: first internal resistance of the first electrical energy storage device 2
r_{ESS2}: second internal resistance of the second electrical energy storage device 6

or:

$$P = {R}_{ESS 1} \cdot {( {I}_{inv} - {I}_{D C / D C}^{HV} )}^{2} + ( 1 - η ) \cdot {V}_{ESS 2} \cdot {I}_{D C / D C}^{HV} + {r}_{ESS 2} \cdot {( \frac{{V}_{ESS 1} \cdot {I}_{D C / D C}^{HV}}{η \cdot {V}_{ESS 2}} )}^{2}$$

The power is thus expressed simply as a function of I_{DC/DC}^{HV}=I. This function must be shunted in order to attempt to obtain a minimum of losses and a corresponding set intensity I.

This minimum is obtained for

$$\frac{d P}{d l} = 0 ,$$

i.e.:

$$I = \frac{1}{2} [ \frac{2 {R}_{ESS 1} \cdot {I}_{inv} - ( 1 - η ) {V}_{ESS 2}}{{R}_{ESS 1} + {r}_{ESS 2}^{2} \cdot {η}^{2} \cdot \frac{{V}_{ESS 1}^{2}}{{V}_{ESS 2}^{2}}} ]$$

The first and second optimum intensities I_{ESS1}, I_{ESS2} circulate respectively in the first and second electrical energy storage devices 2, 6, i.e. those which minimise the losses by thermal dissipation are therefore:

$${I}_{ESS 1} = {I}_{inv} - I$$

$${I}_{ESS 2} = \frac{{V}_{ESS 1} \cdot I}{η \cdot {V}_{ESS 2}}$$

The following example shows the application of the method according to the invention to an architecture of a conventional mild-hybrid type, comprising a first electrical energy storage device 2 constituted by a high voltage lithium-ion battery in the power network 1, and a second electrical energy storage device 6 constituted by a low-voltage lead battery in the service network 5.

The functioning parameters of the first and second storage devices 2, 6 are the following in the case of a discharge:

R_{ESS1}=35 mΩ

r_{ESS2}=5 mΩ

V_{ESS1}=48V

V_{ESS2}=14V

Iᵢₙᵥ=250 A

η=0.95

According to these functioning parameters, the calculation shows that the set intensity is I=95 A, and consequently the first optimum intensity which circulates in the lithium-ion battery 2 is 250 A−95 A=155 A, by applying the preceding formulae.

It can therefore be concluded that an optimum strategy for controlling the energy in order to prevent the losses, determined by the method according to the invention, consists of obtaining 155 A from the lithium-ion battery 2, and the remainder from the lead battery 6, by means of the reversible DC/DC converter 9.

This also means incidentally that an “ideal” power of the converter 9 must be 4.5 kW (95 A*48V).

However, in charging conditions, the charging efficiency with a strong current of a lead battery is relatively low, and its intrinsic resistance increases rapidly, which leads to release of heat and low performance of the system as a whole.

The preceding calculations of the losses by thermal dissipation consequently suggest that the lead battery should be replaced by another type of second electrical energy storage device 6 in the electric service network 5.

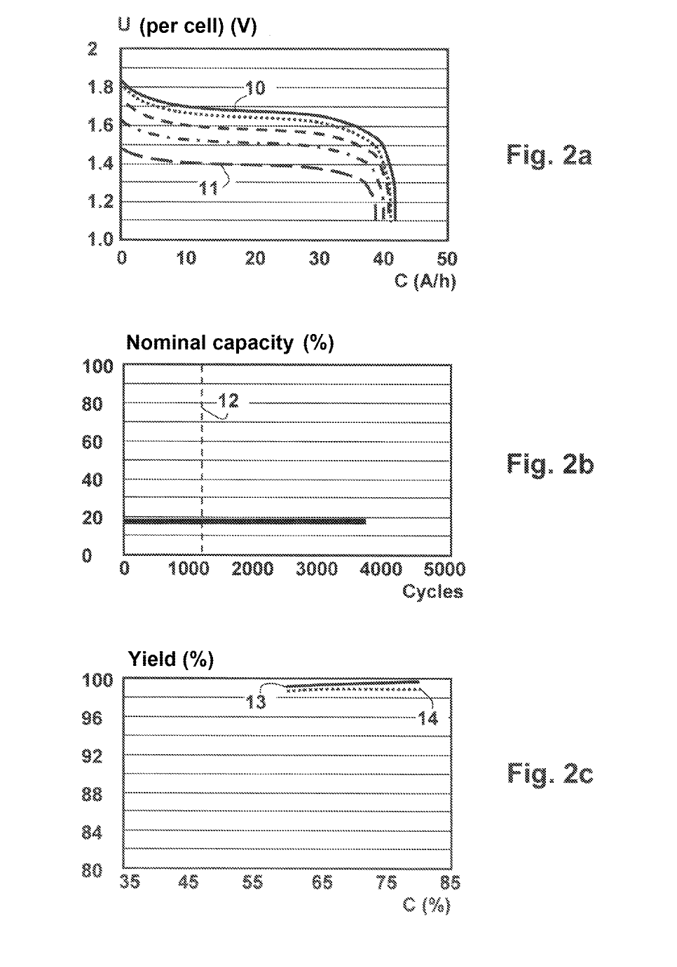

Preferably, this second electrical energy storage device 6 is a nickel-zinc battery which has advantageous functioning parameters, as shown clearly in FIGS. 2a, 2b and 2c, i.e.:

a discharge curve which is substantially flat between 20% and 80% of a nominal capacity (FIG. 2a), in a wide range of discharge currents going from 0.2 times the nominal capacity (curve in a solid line 10) to 10 times the nominal capacity (curve in a broken line 12);

a number of charging/discharging cycles (at approximately 20% of the nominal capacity) greater than a limit 12 of approximately 1000, corresponding to the service life of the best lead batteries (FIG. 2b);

a faradic performance which is substantially 99% or more (FIG. 2c), for functioning temperatures of between 25% (curve in a solid line 13) and 55% (curve in a dotted line 14);

a power density at low temperature higher than 480 W/kg.

The following table 1 establishes by way of example a comparison between a lead battery model and a nickel-zinc battery model available on the market:

TABLE 1

| Parameter | Pb battery | | Ni—Zn battery | |
|---|---|---|---|---|
| Form factor | Parallelepiped | | Parallelepiped | |
| Nominal voltage | 12 | V | 12.8 | V |
| Nominal capacity | 60 | Ah | 40 | Ah |
| Total energy | 720 | Wh | 512 | Wh |
| Energy density | 35 | Wh/kg | 69 | Wh/kg |
| Bare mass | 20.6 | kg | 7.4 | kg |

The method for supplying electric power to a hybrid motor vehicle with dual electrical energy storage devices 2, 6 described above is implemented by an electronic control unit 15 which controls the transfers of energy between the power network 1 and the service network 5.

This electronic control unit 15 makes it possible to minimise the losses by thermal dissipation in the electrical supply of the vehicle, by imposing on the reversible DC/DC converter 9 a functioning point derived from the calculations carried out on the basis of the functioning parameters of the first and second electrical energy storage devices 2, 6, as previously described in detail.

In the example given, this functioning point is 95 A @ 48 V. It is derived from calculation of the set intensity, as a function in particular of the first and second internal resistances of the Li-Ion battery 2 and the lead battery 6.

In order to carry out these calculations, the electronic control unit 15 comprises in a known manner a microcontroller associated with an electronic memory.

It will be appreciated that the invention is not limited simply to the preferred embodiments described above.

A similar description could relate to types of electric motors/generators and electrical energy storage devices 2, 6 different from those specified.

In particular, the first electrical energy storage device 2 is, as an alternative to a lithium-ion battery, a high-temperature battery with molten salts of the “Zebra” type (sodium, nickel chloride), or, if the energy level required is low, and ultra-capacitor of the EDLC type (acronym for Electric Double Layer Capacitor).

Similarly, although the optimum type of second electrical energy storage device 6 is a nickel-zinc battery, alternatively an NiMH battery is advantageous.

The motor/generator 3 is also, as an alternative to an excitation machine, a machine with permanent magnets, or a hybrid machine. In other variants of the power network, the motor/generator 3 is a direct current machine which does not require an inverter 4.

The invention thus incorporates all the possible variant embodiments, provided that these variants remain within the context defined by the following claims.

1. Method for supplying electric power to a hybrid motor vehicle with dual electrical energy storage devices (2, 6) of the type consisting of providing said vehicle firstly with an electric power network (1) comprising an electric motor/generator (3), and a first electrical energy storage device (2) with a first nominal voltage, and secondly with an electric service network (5) comprising a second electrical energy storage device (6) with a second nominal voltage which is lower than said first nominal voltage, said electric power network (1) and said service network (5) being connected to one another by a reversible direct/direct converter (9), wherein a first optimum intensity (IESS1) is determined, which circulates in said first storage device (2), and a second optimum intensity (IESS2) is determined, which circulates in said second storage device (6), according to functioning parameters of said first and second electrical energy storage devices (2, 6), such as to minimize losses by thermal dissipation.

2. Method for supplying electric power to a hybrid motor vehicle with dual electrical energy storage devices (2, 6) according to claim 1, characterized in that said first and second optimum intensities (IESS1, IESS2) are also determined according to a performance level of said reversible direct/direct converter (9).

3. Method for supplying electric power to a hybrid motor vehicle with dual electrical energy storage devices (2, 6) according to claim 2, characterized in that said optimum first and second intensities (I_{ESS1}, I_{ESS2}) are also determined in accordance with a functioning intensity (Iᵢₙᵥ) which circulates in a branch of said electric power network (1) comprising said motor/generator (3).

4. Method for supplying electric power to a hybrid motor vehicle with dual electrical energy storage devices (2, 6) according to claim 3, characterized in that said optimum first and second intensities (I_{ESS1}, I_{ESS2}) are also determined by the equations:
$${I}_{ESS 1} = {I}_{inv} - I$$
$${I}_{ESS 2} = \frac{{V}_{ESS 1} \cdot I}{η \cdot {V}_{ESS 2}}$$
where I is a set intensity provided by the expression:
$$I = \frac{1}{2} [ \frac{2 {R}_{ESS 1} \cdot {I}_{inv} - ( 1 - η ) {V}_{ESS 2}}{{R}_{ESS 1} + {r}_{ESS 2}^{2} \cdot {η}^{2} \cdot \frac{{V}_{ESS 1}^{2}}{{V}_{ESS 2}^{2}}} ]$$
wherein:
R_{ESS1} is a first internal resistance of said first electrical energy storage device (2)
r_{ESS2} is a second internal resistance of said second electrical energy storage device (5)
Iᵢₙᵥ is said intensity of functioning
η is said performance
V_{ESS1} is a first functioning voltage of said first electrical energy storage device (2)
V_{ESS2} is a second functioning voltage of said second electrical energy storage device (6).

5. Method for supplying electric power to a hybrid motor vehicle with dual electrical energy storage devices (2, 6) according to claim 1, characterized in that said functioning parameters are electric parameters of a lithium-ion battery and a nickel-zinc battery.

6. System for supplying electric power to a hybrid motor vehicle with dual electrical energy storage devices (2, 6) which can implement the method according to claim 1, of the type comprising firstly an electric power network (1) comprising an electric motor/generator (3), and a first electrical energy storage device (2) with a first nominal voltage, and secondly an electric service network (5) comprising a second electrical energy storage device (6) with a second nominal voltage which is lower than said first nominal voltage, said electric power network (1) being connected to said service network (5) by a reversible direct/direct converter (9), characterized in that it additionally comprises an electronic control unit (15) which controls a set intensity which circulates in said reversible direct/direct converter (9) according to functioning parameters of said first and second electrical energy storage devices (2, 6).

7. System for supplying electric power to a hybrid motor vehicle with dual electrical energy storage devices (2, 6) according to claim 6, characterized in that said second electrical energy storage device (6) has:
a discharge curve (10, 11) which is substantially flat between 20% and 80% of a nominal capacity;
a number of charging/discharging cycles greater than 1000 (12);
a faradic performance which is substantially 99% or more (13, 14);
a power density at low temperature higher than 480 W/kg.

8. System for supplying electric power to a hybrid motor vehicle with dual electrical energy storage devices (2, 6) according to claim 7, characterized in that said second electrical energy storage device (6) is a nickel-zinc battery.

9. Electronic control unit (15) which can be integrated in an electrical supply system of a hybrid motor vehicle with dual electrical energy storage devices (2, 6) according to claim 6, characterized in that it comprises an electronic memory comprising data representative of the functioning parameters of said first and second electrical energy storage devices (2, 6), and a computer code which is representative of the method.

10. Hybrid motor vehicle comprising an electrical supply system with dual electrical energy storage devices (2, 6) according to claim 6.

11. Method for supplying electric power to a hybrid motor vehicle with dual electrical energy storage devices (2, 6) according to claim 2, characterized in that said functioning parameters are electric parameters of a lithium-ion battery and a nickel-zinc battery.

12. Method for supplying electric power to a hybrid motor vehicle with dual electrical energy storage devices (2, 6) according to claim 3, characterized in that said functioning parameters are electric parameters of a lithium-ion battery and a nickel-zinc battery.

13. Method for supplying electric power to a hybrid motor vehicle with dual electrical energy storage devices (2, 6) according to claim 4, characterized in that said functioning parameters are electric parameters of a lithium-ion battery and a nickel-zinc battery.

14. System for supplying electric power to a hybrid motor vehicle with dual electrical energy storage devices (2, 6) which can implement the method according to claim 2, of the type comprising firstly an electric power network (1) comprising an electric motor/generator (3), and a first electrical energy storage device (2) with a first nominal voltage, and secondly an electric service network (5) comprising a second electrical energy storage device (6) with a second nominal voltage which is lower than said first nominal voltage, said electric power network (1) being connected to said service network (5) by a reversible direct/direct converter (9), characterized in that it additionally comprises an electronic control unit (15) which controls a set intensity which circulates in said reversible direct/direct converter (9) according to functioning parameters of said first and second electrical energy storage devices (2, 6).

15. System for supplying electric power to a hybrid motor vehicle with dual electrical energy storage devices (2, 6) which can implement the method according to claim 3, of the type comprising firstly an electric power network (1) comprising an electric motor/generator (3), and a first electrical energy storage device (2) with a first nominal voltage, and secondly an electric service network (5) comprising a second electrical energy storage device (6) with a second nominal voltage which is lower than said first nominal voltage, said electric power network (1) being connected to said service network (5) by a reversible direct/direct converter (9), characterized in that it additionally comprises an electronic control unit (15) which controls a set intensity which circulates in said reversible direct/direct converter (9) according to functioning parameters of said first and second electrical energy storage devices (2, 6).

16. System for supplying electric power to a hybrid motor vehicle with dual electrical energy storage devices (2, 6) which can implement the method according to claim 4, of the type comprising firstly an electric power network (1) comprising an electric motor/generator (3), and a first electrical energy storage device (2) with a first nominal voltage, and secondly an electric service network (5) comprising a second electrical energy storage device (6) with a second nominal voltage which is lower than said first nominal voltage, said electric power network (1) being connected to said service network (5) by a reversible direct/direct converter (9), characterized in that it additionally comprises an electronic control unit (15) which controls a set intensity which circulates in said reversible direct/direct converter (9) according to functioning parameters of said first and second electrical energy storage devices (2, 6).

17. System for supplying electric power to a hybrid motor vehicle with dual electrical energy storage devices (2, 6) which can implement the method according to claim 5, of the type comprising firstly an electric power network (1) comprising an electric motor/generator (3), and a first electrical energy storage device (2) with a first nominal voltage, and secondly an electric service network (5) comprising a second electrical energy storage device (6) with a second nominal voltage which is lower than said first nominal voltage, said electric power network (1) being connected to said service network (5) by a reversible direct/direct converter (9), characterized in that it additionally comprises an electronic control unit (15) which controls a set intensity which circulates in said reversible direct/direct converter (9) according to functioning parameters of said first and second electrical energy storage devices (2, 6).

18. Electronic control unit (15) which can be integrated in an electrical supply system of a hybrid motor vehicle with dual electrical energy storage devices (2, 6) according to claim 7, characterized in that it comprises an electronic memory comprising data representative of the functioning parameters of said first and second electrical energy storage devices (2, 6), and a computer code which is representative of the method.

19. Electronic control unit (15) which can be integrated in an electrical supply system of a hybrid motor vehicle with dual electrical energy storage devices (2, 6) according to claim 8, characterized in that it comprises an electronic memory comprising data representative of the functioning parameters of said first and second electrical energy storage devices (2, 6), and a computer code which is representative of the method.

20. Hybrid motor vehicle comprising an electrical supply system with dual electrical energy storage devices (2, 6) according to claim 7.

21. Hybrid motor vehicle comprising an electrical supply system with dual electrical energy storage devices (2, 6) according to claim 8.
